(19) United States
(12) Patent Application Publication
(10) Pub. No.: US 2008/0245677 A1
(43) Pub. Date: Oct. 9, 2008

(54) Oral Care Package

(76) Inventor: Ralph Albert Sagel, Loveland, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/062,604

(22) Filed: Apr. 4, 2008

Related U.S. Application Data
(60) Provisional application No. 60/922,196, filed on Apr. 5, 2007.

(51) Int. Cl. A61C 19/02

(52) U.S. Cl. 206/63.5

(57) ABSTRACT

An oral care package includes a primary package for containing an oral composition and having a first window and a secondary package at least partially encompassing the primary package and having a second window, wherein the first and second windows are positioned on the respective first and second packages such that the oral composition contained within the primary package is visible through the first and second windows. A method of displaying an oral composition, comprising forming a primary package for holding an oral composition, forming a first window in the primary package, forming a secondary package, forming a second window in the secondary package, placing an oral composition within a reservoir of the primary package, and positioning the primary package at least partially inside the secondary package such that the oral composition is visible through the first and second windows.

### CROSS REFERENCE TO RELATED APPLICATIONS

This application claims the benefit of U.S. Provisional Application No. 60/922,196, filed Apr. 5, 2007.

### FIELD OF THE INVENTION

The present invention relates to product packaging. More particularly, an oral care package assembly for holding and displaying an oral composition.

### BACKGROUND OF THE INVENTION

There is a wide variety of commercially available product packaging. In many cases these packages are designed to meet specific functional requirements. For example, the packages may be designed to meet certain size constraints, certain shelf life, or specific product protection criteria.

In some cases, these packages are designed such that the outside of the package is used to communicate to the consumer. As an example, the outside of the packages may be printed to provide product information such as product ingredients to the consumer. Moreover, the outside surface of the packages may contain artwork, trademarks, and other information to assist in marketing the product contained within the package.

But there remains a continuous need for new packages that provide an improved balance between both functional requirements and marketing and communication requirements.

### SUMMARY OF THE INVENTION

The present invention is directed to an oral care package assembly for holding and displaying an oral composition.

One exemplary embodiment of the present invention is an oral care package that includes a primary package for containing an oral composition and having a first window and a secondary package at least partially encompassing the primary package and having a second window, wherein the first and second windows are positioned on the respective first and second packages such that the oral composition contained within the primary package is visible through the first and second windows.

Another embodiment of the present invention is an oral care package assembly, comprising a dispenser for an oral composition, wherein at least a portion of the dispenser is generally transparent, and a secondary package at least partially encompassing the dispenser, wherein at least a portion of the secondary package is generally transparent. The respective generally transparent portions of the dispenser and the secondary package are at least partially aligned such that the oral composition contained within the dispenser is visible through the respective generally transparent portions of the dispenser and the secondary package.

An exemplary method of the present invention is a method of displaying an oral composition, comprising forming a primary package for holding an oral composition, forming a first window in the primary package, forming a non-shrink wrap secondary package, forming a second window in the secondary package, placing an oral composition within a reservoir of the primary package, and positioning the primary package at least partially inside the secondary package such that the oral composition is visible through the first and second windows.

Embodiments are described in further detail herein, and these and other features, aspects, and advantages of the present invention will become evident to those skilled in the art from a reading of the present disclosure.

### BRIEF DESCRIPTION OF THE DRAWINGS

While the specification concludes with claims particularly pointing out and distinctly claiming the invention, it is believed the same will be better understood from the following description taken in conjunction with the accompanying drawings in which:

FIG. 1 is a side elevational view of an exemplary package assembly according to an embodiment of the present invention;

FIG. 2 is a side elevational view of the exemplary primary package according to FIG. 1;

FIG. 3 is a side elevational view of the exemplary secondary package according to FIG. 1;

FIG. 4 is a side elevational view of an exemplary secondary package according to an embodiment of the present invention;

FIG. 5 is a side elevational view of an exemplary package assembly according to an embodiment of the present invention;

FIG. 6 is a side elevational view of an exemplary package assembly according to an embodiment of the present invention;

FIG. 7 is a side elevational view of an exemplary package assembly according to an embodiment of the present invention;

FIG. 8 is a side elevational view of an exemplary package assembly according to an embodiment of the present invention; and

FIG. 9 is a side elevational view of an exemplary package assembly according to an embodiment of the present invention.

The embodiments set forth in the drawings are illustrative in nature and not intended to be limiting of the invention defined by the claims. Moreover, individual features of the drawings and the invention will be more fully apparent and understood in view of the detailed description.

### DETAILED DESCRIPTION OF THE INVENTION

While the specification concludes with claims that particularly point out and distinctly claim the invention, it is believed the present invention will be better understood from the following description.

### A. DEFINITIONS

The term “oral composition” as used herein means a product that in the ordinary course of usage is not intentionally swallowed for purposes of systemic administration of particular therapeutic agents, but is rather retained in the oral cavity for a time sufficient to contact substantially all of the dental surfaces and/or oral tissues for purposes of oral activity. The oral composition of the present invention may be in various forms including toothpaste, dentifrice, tooth gel, subgingival gel, foam, mouse, or denture product. The oral composition may also be incorporated onto strips or films for direct application or attachment to oral surfaces.

The term “dentifrice” as used herein means paste, gel, powder, rinses, or liquid formulations, unless otherwise specified, that are used to clean, protect, and/or penetrate the surfaces of the oral cavity.

The term “polymer” as used herein shall include materials whether made by polymerization of one type of monomer or made by two (i.e., copolymers) or more types of monomers.

The term “visually distinct” as used herein means a difference clearly perceived by sight.

The term “container” as used herein means a receptacle in which material such as oral composition is held or carried.

The term “opaque” as used herein means not transparent, generally transparent, or translucent; not allowing light to pass through.

The term “transparent” as used herein means capable of transmitting light so that objects or images are seen as if there was no intervening material.

The term “translucent” as used herein means that light is diffused as it passes through so that objects or images are seen, but without clarity.

The term “generally transparent container” as used herein means that at least some of the container is capable of being seen through so that the appearance of the container's contents may be visualized. The term includes transparent and translucent containers, wherein contents in a transparent container can be more clearly visualized than those in a translucent container. For purposes of the invention, as long as one wavelength in the visible light range has greater than 25% transmittance, it is considered to be generally transparent.

The term “secondary package” as used herein means any package, container, and/or dispenser that is capable of at least partially encompassing or enclosing a primary package, but it does not include flexible films, such as shrink wrap films.

The term “pattern” as used herein means a decorative or distinctive design, not necessarily repeating or imitative, including but not limited to the following: geometric, helical, swirl, arrayed, spiral, tessellated, starburst, lobed, lightning, blocks, and combinations thereof.

The term “dispense” or “dispensing” as used herein means to administer or remove.

The term “dispenser” as used herein means any pump, tube, package, or container suitable for dispensing product.

The term “longitudinal axis” as used herein means the longest axis of a body.

The term “oriented” as used herein means aligned or positioned.

The term “parallel” as used herein means extending in the same direction and having common perpendiculars.

The term “adjacent” as used herein means adjoining or neighboring.

The term “colored” as used herein means having color.

The term “tinted” as used herein means a gradation of color made by adding white to it to lessen its saturation.

The term “shaded” as used herein means the degree of darkness of a color, determined by the quantity of black or by the lack of illumination.

The term “frosted” as used herein means a decoration or coating added to a surface.

The term “textured” as used herein means having surface roughness.

The term “overlap” as used herein means to cover over a part of, or to have an area in common.

The term “cylindrical” as used herein means having the shape of a cylinder, that is a tube with a consistent cross-sectional area and two equally-sized circular ends.

The term “non-cylindrical” as used herein means any and all shapes that are not a tube with a consistent cross-sectional area and two equally-sized circular ends.

### B. EXEMPLARY EMBODIMENTS

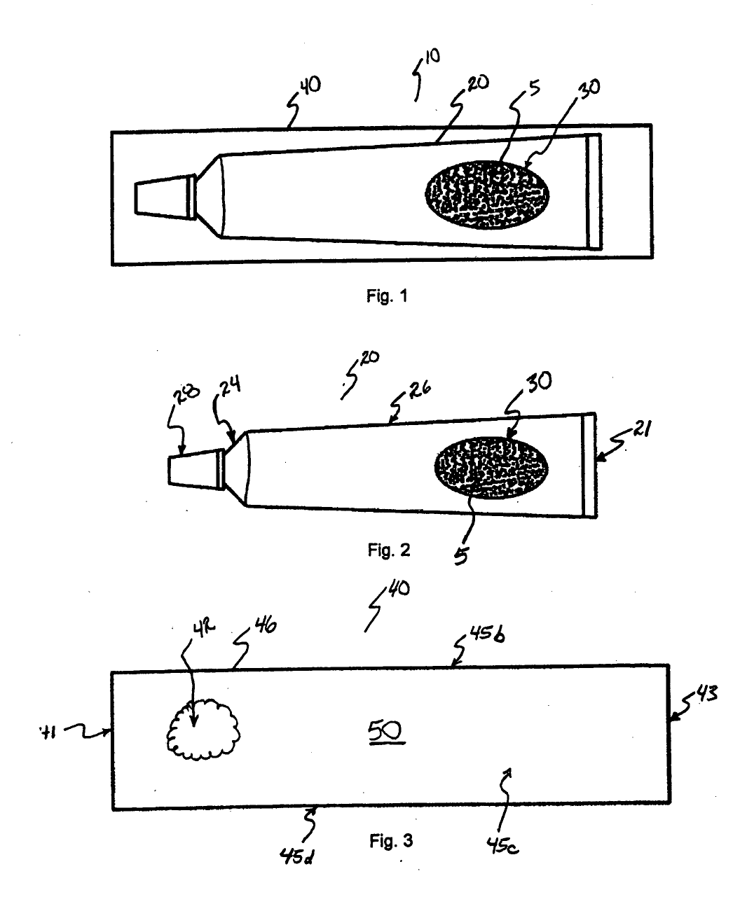

Referring to FIGS. 1-3, an exemplary embodiment of a package assembly of the present invention is shown generally as 10. Package assembly 10 may comprise a primary package 20 for holding a product such as for example, an oral composition 5, and a secondary package 40 at least partially encompassing primary package 20. As shown in the exemplary embodiment, primary package 20 is completely enclosed or encompassed within secondary package 40.

Primary package 20 may be of any shape, size, or configuration and comprise any package, container, and/or dispenser suitable for holding a product such as oral composition 5, which may include the capabilities of containing, storing, packaging, and/or dispensing oral composition 5 as known to one of ordinary skill in the art. Examples of primary package 20 may include, but not be limited to, tubes (e.g., flexible tubes, stand-up tubes), bottles, tottles, thermoforms, pouches, sachets, stand-up containers, pump dispensers, jars, or any other package as known to one of ordinary skill in the art. Primary package 20 may be any shape such as a cylindrical or non-cylindrical shape as defined above herein. In addition, the primary package may have one shaped such as cylindrical before it is filled with a product, and then once filled and/or sealed, it may have a second shape such as non-cylindrical. Exemplary sizes of primary package 20 may comprise a single dose up to 14 ounces of product storage capability.

FIG. 2 shows primary package 20 comprising a non-cylindrical tube dispenser (e.g., a toothpaste tube) comprising a housing 26 having a sealed end 21, a shoulder 24 connected to housing 26 opposite sealed end 21, a reservoir (not shown) defined by and within shoulder 24 and housing 26, a nozzle (not shown) connected to shoulder 24 opposite housing 26 and in fluid communication with reservoir 22, and a cap 28 threaded to the nozzle. It is understood, as set forth above, any container shape that does not have two equally-sized circles on the ends is non-cylindrical. The exemplary non-cylindrical shape may be such as found in conventional flexible 2 tubes, wherein sealed end 21 has a different shape and size than shoulder 24. Exemplary methods of dispensing oral composition 5 from primary package 20 include, for example, squeezing housing 26, manipulating a pump mechanism (not shown), or using gravity as known to one of ordinary skill in the art.

Shoulder 24, the nozzle, and cap 28 may be fabricated from a variety of conventional materials such as polymers, metals, composites, and combinations of the same, including but not limited to polypropylene (PP), polyethylene (PE), polycarbonate (PC), polyamides (PA), polyethylene terephthalate (PETE), polyvinylchloride (PVC), general purpose polystyrene (GPPS), polystyrene (PS) and copolymers of the same, and using any conventional method such as injection molding, blow bolding compression molding, etc. In the exemplary embodiment, the shoulder, nozzle, and cap are fabricated from a semi-rigid to rigid material. Housing 26 may comprise a single layer laminate, substrate, and/or material, or multiple layer laminate, substrate, or material(s) as known to one of ordinary skill in the art, including but not limited to foil, polymers, plastics, composites, and combinations thereof. In the exemplary embodiment shown, housing 26 is a flexible laminate forming a flexible walled-tube. Exemplary foil layer(s) may include, but not be limited to aluminum, tin, and other conventional metals. Exemplary polymers may include polypropylene (PP), polyethylene (PE), polycarbonate (PC), polyamides (PA), polyethylene terephthalate (PETE), polyvinylchloride (PVC), general purpose polystyrene (GPPS), polystyrene (PS), EVOH, Nylon, and copolymers of the same. Alternatively, shoulder 24, the nozzle, and housing 26 may be fabricated as a single, integral unit from one or more materials as a single or multiple layer container.

In one exemplary embodiment, the present invention modifies a commercially available flexible, non-cylindrical tube dispenser, such as 3224 plastic laminate from Essel Propack, to include a window 30 to form primary package 20. Window 30 may be formed from at least a portion of housing 26 and/or shoulder 24 that is generally transparent such that oral composition 5 is visible through this generally transparent portion (i.e., window 30) from outside primary package 20. Housing 26 and window 30 may be fabricated from two or more completely different materials or the same material so long as window 30 is at least generally transparent.

Exemplary materials from which the generally transparent portion, i.e., window 30, may be made include, but are not limited to, polypropylene (PP), polyethylene (PE), polycarbonate (PC), polyamides (PA), polyethylene terephthalate (PETE), polyvinylchloride (PVC), general purpose polystyrene (GPPS), and polystyrene (PS). The generally transparent portion of said container may have a transmittance of more than 25%, 30%, 40%, 50%, 60% or even more than 70% in the visible part of the spectrum (approx. 410-800 nm). For purposes of the invention, as long as one wavelength in the visible light range has greater than 25% transmittance, it is considered to be generally transparent. The generally transparent material used to fabricate window 30 may also be used to fabricate the remainder of housing 26 (not including window 30), except the material comprising the remainder of housing's 26 may be colored, tinted, frosted, shaded, or patterned to cause housing 26 to be opaque or not generally transparent. The material comprising window 30 may also be colored, tinted, frosted, shaded, or patterned just as long as window 30 is still generally transparent such that oral composition 5 is visible through window 30 from outside primary package 20. However, as will be shown and described below herein, window 30 may also comprise either the entire or substantially the entire housing 26 and/or shoulder 24, and thus, the entire or substantially the entire housing 26 and/or shoulder 24 may be fabricated from a generally transparent material to form window 30 (shown in FIGS. 5 and 6 and described below herein).

As shown in FIG. 1, housing 26, except window 30, may comprise a material that is opaque or not generally transparent. Thus, one wavelength in the visible light range does not have greater than 25% transmittance through housing 26. Exemplary non-generally transparent materials that may be used to fabricate housing 26, include but are not limited to, foil, opaque polymers, other opaque materials, and any combinations thereof. Exemplary opaque polymers may comprise polymers such as polypropylene (PP), polyethylene (PE), polycarbonate (PC), polyamides (PA), polyethylene terephthalate (PETE), polyvinylchloride (PVC), general purpose polystyrene (GPPS), polystyrene (PS), and copolymers of the same, wherein colorants or opacifiers such as TIO2 have been added to the polymers. In yet another exemplary embodiment, a two shot injection molding process may be used to form a single molded primary package 20 having window 30 fabricated from a first generally transparent material and housing 26 fabricated from a second generally transparent material.

In one exemplary embodiment, primary package 20 would comprise starting with a plastic tube that is entirely transparent, then opaquely printing over a portion or a substantial portion of the transparent tube, except for a portion of the tube that is desired to form or comprise window 30. This portion desired to comprise window 30 is not opaquely printed on, but left as a transparent plastic window. Thus, a product contained within primary package 20 is only visible through window 30 because the remainder of the package is opaque due to the print.

Alternatively, window 30 may comprise an actual opening disposed within housing 26 and a second generally transparent material, such as a flexible film, connected to housing 26 using conventional methods such as adhesive, heat sealing, etc., to enclose the opening. The housing may be cut or formed to create the opening therethrough. As such, window 30 permits oral composition 5 contained within primary package 20 to be visible from outside primary package 20.

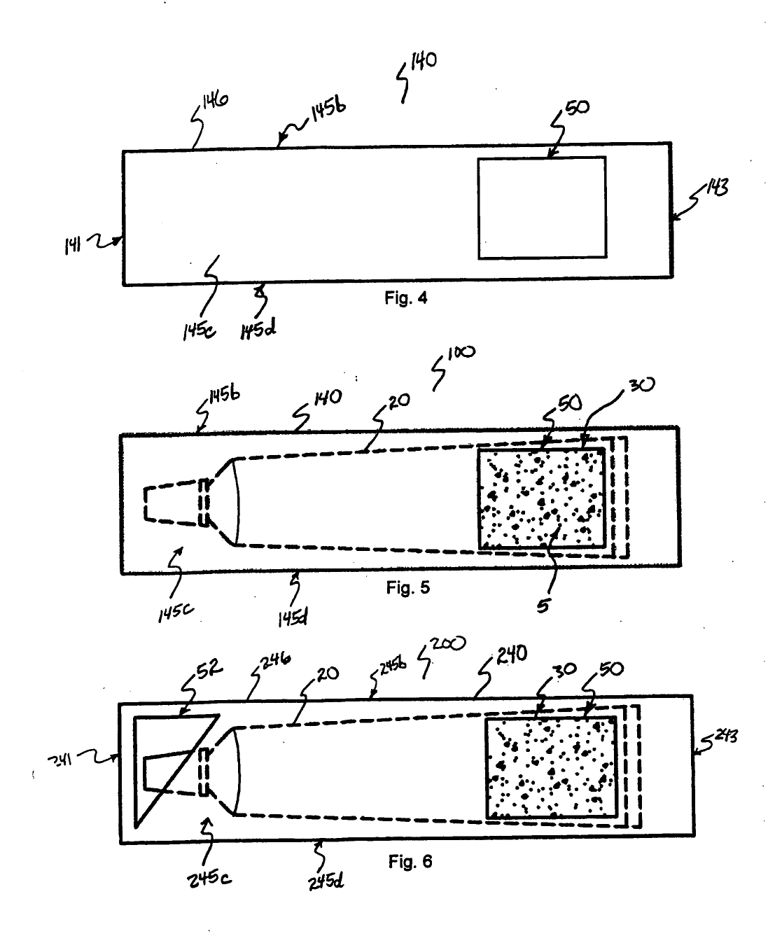

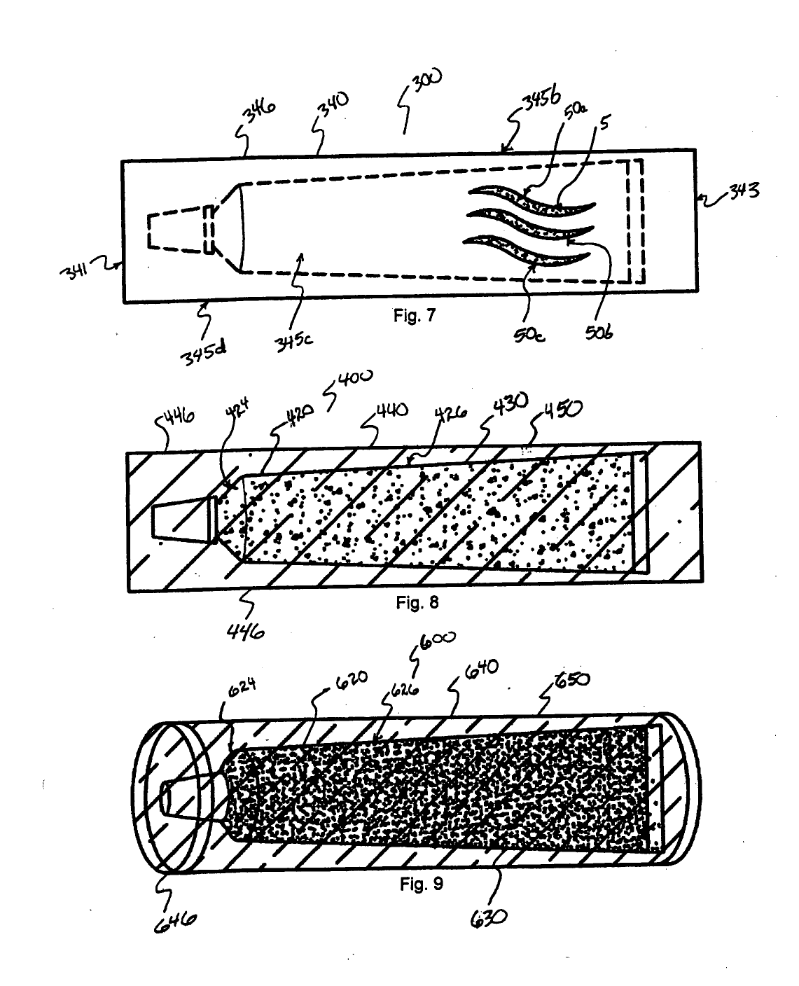

In FIG. 2, window 30 is shown as having a generally oval-shaped. However, it is understood that window 30 may comprise a variety of shapes, sizes, and configurations, including but not limited to any geometric shapes, non-geometric shapes, patterns, slits, etc., as known to one of ordinary skill in the art. For example, FIGS. 4 and 5 show other exemplary embodiments of the present invention, wherein window 30 comprise a rectangular shape. FIG. 7 shows another exemplary embodiment, wherein window 30 may comprise a slit or multiple slits disposed along, within, and/or through housing 26. It is also understood that primary package may include multiple windows 30 such as shown in FIGS. 6 and 7 or any combinations thereof.

Referring to FIG. 3, oral composition package assembly 10 also includes secondary package 40 that may partially or completely encompass or enclose primary package 20. Secondary package 40 includes a housing 46 that encompasses and defines a reservoir 42. Referring to FIG. 1, reservoir 42 is capable of holding and/or containing primary package 20. In the exemplary embodiment, secondary package 40 may comprise a rectangle-shaped carton defining housing 46, which includes a top wall 41, a bottom wall 43, and four (4) side walls 45a-d as known to one of ordinary skill in the art. Side wall 45a is not shown, but is the opposite, parallel wall from side wall 45c. Secondary package 40 may include a window 50. Window 50 may comprise at least a portion of one or more of the walls. As shown in FIGS. 1 and 3, the exemplary embodiment window 50 comprises the entire surface area of side wall 45c. As such, side wall 45c is generally transparent and thus fabricated from a material that is generally transparent. Exemplary materials that are generally transparent include polypropylene (PP), polyethylene (PE), polycarbonate (PC), polyamides (PA), polyethylene terephthalate (PETE), polyvinylchloride (PVC), general purpose polystyrene (GPPS), and polystyrene (PS), or any combinations thereof. The walls 41, 43, and 45a-d do not comprise flexible films such as shrink wrap. In this exemplary embodiment, one or more of walls 41, 43, and 45a-d may be semi-rigid to provide protection to primary package 20 held within secondary package 40 during shipping, storage, and handling.

An exemplary secondary package 40 may be commercially available as a plastic carton available from Mead WestVaco, wherein secondary package 40 comprises semi-rigid, plastic walls 41, 43, and 45a-d that are all generally transparent. In such an exemplary embodiment, window 50 comprises the entire or a substantial portion of housing 46 of secondary package 40. In this exemplary embodiment, the walls are semi-rigid and thus do include flexible films such as shrink wrap in order to provide protection to primary package 20 held within secondary package 40 during shipping, storage, and handling. In one exemplary embodiment, secondary package 40 comprises a semi-rigid package or non-flexible film package, wherein walls 41, 43, 45a-d have a thickness of greater than about 3 mils. In another exemplary embodiment of a semi-rigid package or non-flexible film package, semi-rigid walls 41, 43, and 45a-d have a thickness from about 4 mils to about 18 mils, providing package 40 with its semi-rigidity.

Windows 30 and 50 are positioned along primary package 20 and secondary package 40, respectively, such that oral composition 5 held at least partially within primary package 20 is visible through both windows 30 and 50 from outside secondary package 40. It is understood that primary package 20, window 30, secondary package 40, and/or window 50 may comprise a variety of shapes, sizes, configurations, and materials as known to one of ordinary skill in the art, as long as oral composition 5 held within primary package 20 is visible through both windows 30 and 50 from outside secondary package 40.

Referring to FIGS. 4-5, another exemplary embodiment of a dual package or package assembly of the present invention is shown generally as 100. Package assembly 100 may comprise primary package 20 as shown and described above herein and a secondary package 140. The exemplary embodiment comprises a housing 146 that includes a top wall 141, a bottom wall 143, and four (4) side walls 145a-d. Secondary package 140 may be the same or similar as shown and described above herein, except that window 50 comprises only a rectangle-shaped portion of one of side walls, e.g., side wall 145c as shown in FIG. 4. The remainder of side wall 145c (i.e., the surface area excluding window 50) may be opaque or not generally transparent. Side wall 145c may be fabricated from one or more exemplary materials, including but not limited to paper, cardboard, foils, metals, opaque plastics, opaque polymers, composites, or any combinations thereof. Additionally, one or more of the other walls (e.g., top wall 141, bottom wall 143, and side walls 145a,b,d) may also be opaque or not generally transparent. Alternatively, generally transparent materials as described above herein may also be used for the remainder of side wall 145c (i.e., the surface area excluding window 50) and/or one or more of the other walls (e.g., top wall 141, bottom wall 143, and side walls 145a,b,d). However, the generally transparent material of this remainder of side wall 145c and/or one or more of the other walls of housing 146 may be colored, tinted, frosted, shaded, patterned, or covered with a label such that such that primary package 20 and/or oral composition 5 are not visible through housing 146 except through windows 30 and 50.

When primary package 20 is positioned within secondary package 140, windows 30 and 50 are disposed along respective primary and secondary packages 20 and 140 such that the windows are partially, substantially, or completely aligned as shown in FIG. 5. The at least partial alignment of windows 30 and 50 cause oral composition 5 held within primary package 20 to be visible through both windows 30 and 50 from outside secondary package 140.

FIG. 6 shows another exemplary embodiment of a package assembly 200 of the present invention. Package assembly 200 may comprise primary package 20 as shown and described above herein and a secondary package 240. The exemplary embodiment comprises a housing 246 that includes a top wall 241, a bottom wall 243, and four (4) side walls 245a-d. Secondary package 240 may be the same or similar as shown and described above herein, except that a side wall (e.g., side wall 245c) comprises a first window 50 and a second window 52 as shown in FIG. 6.

Windows 50 and 52 may be disposed any where along secondary package 240. As an example, FIG. 6 shows window 50 being positioned along side wall 245c, and window 52 being positioned along the same side wall 245c near top wall 241. In this configuration, window 50 comprises only a portion of side wall 245c and is positioned such that it is at least partially aligned with window 30 such that oral composition 5 is visible from outside secondary package 240. In addition, window 52 is positioned such that cap 28 is also visible from outside secondary package 240. As shown in FIG. 5, the remainder of side wall 245c, which excludes windows 50 and 52, may be opaque or not generally transparent. Side wall 245c may be fabricated from one or more exemplary materials, including but not limited to paper, cardboard, foils, metals, opaque plastics, opaque polymers, composites, or any combinations thereof. Additionally, generally transparent materials as described above herein may also be used for side wall 245c and then such generally transparent material may be colored, tinted, frosted, shaded, patterned, or covered with a label such that side wall 245c is opaque or not generally transparent such that primary package 20 and/or oral composition 5 is not visible through side wall 245c.

Referring to FIG. 7, another exemplary embodiment of a package assembly of the present invention is shown generally as 300. Package assembly 300 is shown as including primary package 20 as shown and described above herein and a secondary package 340. Secondary package 340 may comprise a housing 346 that is the same and/or similar to the housings of the secondary package shown and described above herein as well. As shown, housing 346 includes a top wall 341, a bottom wall 343, and four (4) side walls 345a-d.

Housing 346 includes a window 50 disposed along side wall 345c. Window 50 in this embodiment comprises one or more slits 50a-c disposed within side wall 345c. Slits 50a-c may comprise a pattern such as the wave pattern shown here to provide additional decorative, marketing or other appeal to the consumer. Window 30 of primary package 20 may comprise a variety of shapes, sizes, or configurations, including a plurality of slits that align with slits 50a-c of the secondary package. As can be seen, slits 50a-c and window 30 are both positioned such that when primary package 20 is positioned within secondary package 340, a consumer can view oral composition 5 held within primary package 20 through window 30 and slits 50a-c from outside secondary package 340.

Again, as shown and described with reference to the exemplary embodiments in FIGS. 5 and 6, side wall 345c shown in FIG. 7 may also comprise a material that is opaque or not generally transparent, permitting oral composition 5 to only be visible through slits 50a-c. The same types of materials or combination of materials may be used as described above herein. It is also understood that multiple windows such as window 52 may also be disposed along side wall 345c as shown in FIG. 6 in combination with slits 50a-c. Although not shown, it is understood that windows 50 and/or 52 may be disposed along the top and/or bottom walls of any of the exemplary embodiments shown and described herein.

FIG. 8 shows yet another exemplary embodiment of a package assembly 400 of the present invention. In the exemplary embodiment, package assembly 400 comprises a primary package 420 encompassed by and/or enclosed within a secondary package 440. Primary package comprises a housing 426, a shoulder 424, and a window 30 as shown and described above herein. Window 30 comprises a substantial portion of primary package 420. For example, housing 426 and shoulder 424 are generally transparent and form window 30. Additionally, secondary package 440 comprises a housing 446 and a window 450. As such, window 450 comprises the entire secondary package 440. As such, the entire housing 446 is generally transparent, forming window 450. When primary package 420 is positioned within secondary package 440, oral composition 5 is visible through housing 426 and shoulder 424, acting as window 430, and housing 446, acting as window 450, from outside secondary package 440. Also, primary package 420 is visible through housing 446 from outside secondary package 440. Primary package 420 and secondary package 440 may be fabricated form the exemplary generally transparent materials described above herein.

In FIG. 9, still yet another exemplary embodiment of a package assembly of the present invention is generally shown as 600. Package assembly 600 includes a primary package 620 encompassed by or enclosed within a secondary package 640. Primary package 620 comprises a shoulder 624 and a housing 626. Window 630 may comprise a substantial portion of primary package 620. In this exemplary embodiment, window 630 comprises shoulder 624 and housing 626 that are generally transparent.

Secondary package 640 has a cylindrical shaped housing 646 and a window 650. Window 650 comprises the entire secondary package 640. As such, the entire housing 646 is generally transparent to form window 650. When primary package 620 is positioned within secondary package 640, oral composition 5 is visible through housing 626 and shoulder 624 (i.e., window 630) and housing 646 (i.e., widow 650) from outside secondary package 640. Additionally, primary package 620 is visible through housing 646 from outside secondary package.

In the exemplary embodiments of the present invention, the package assembly permits oral composition 5 and/or all or a portion of primary package (e.g. package 20) to be viewed by a consumer and/or user through the respective windows (e.g., 30 and 50) of the primary and secondary packages from outside the secondary package, yet still provide necessary protection and sealing to maintain the integrity of the oral composition held within the reservoir of the primary package. It is understood that windows 30, 50, 52, 430, 450, 630, and/or 650, singularly or in combination, may also be transparent, translucent, colored, tinted, frosted, shaded, or patterned. In one aspect, at least 5%, 10%, 20%, 30%, 40%, 50%, 60%, 70%, 80%, 90%, or even 100% of the primary package and/or the secondary package's surface area may be generally transparent.

It is understood that one or more of the windows 30, 50, 52, 430, 450, 630, and/or 650 of the present invention may each comprise a total surface area of greater than or equal to 1 cm², more particularly greater than 1 cm². Even more particularly, one or more of the windows of the present invention may each comprise a total surface area of greater than 2 cm², more particularly greater than 4 cm².

Any portion or the entire portion of the primary package, secondary package, and any of their respective components, including but not limited to the exemplary embodiments shown and described herein, may be tinted, shaded, colored, frosted, patterned, or striped. Such container appearances may be achieved, for example, by including colorant in the resin during manufacture of the packages, or any of its components. The appearances may also be attained by adding decorations to a finished container, or by printing on, embossing, or stamping an already-manufactured container. In addition, any combination of the described methods could be used to create various container appearances.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An oral care package, comprising:
a primary package for containing an oral composition and having a first window; and
a secondary package at least partially encompassing the primary package and having a second window;
wherein the first and second windows are positioned on the respective first and second packages such that the oral composition contained within the primary package is visible through the first and second windows.

2. The package of claim 1, wherein each of the first and second windows each have a total area of greater than 1.0 cm².

3. The package of claim 1, wherein the second window comprises a slit disposed within a wall of the secondary package.

4. The package of claim 3, wherein a generally transparent plastic encloses the slit to form the second window.

5. The package of claim 1, wherein the second window comprises a plurality of slits disposed within a wall of the secondary package, and wherein the plurality of slits form a decorative design.

6. The package of claim 1, wherein the secondary package entirely encompasses the primary package.

7. The package of claim 1, wherein the secondary package is rectangle-shaped.

8. The package of claim 1, wherein the shape of the secondary package is cylindrical.

9. The package of claim 1, wherein the first window comprises substantially the entire primary package.

10. The package of claim 1, wherein at least a portion of the primary package is formed from a generally transparent material to form the first window.

11. The package of claim 1, wherein the first window is transparent.

12. The package of claim 1, wherein the first window is translucent.

13. The package of claim 1, wherein the second window comprises substantially the entire secondary package.

14. The package of claim 1, wherein at least a portion of the secondary package is formed from a generally transparent material to form the second window.

15. The package of claim 1, wherein the second window is transparent.

16. The package of claim 1, wherein the second window is translucent.

17. The package of claim 1, wherein the second window is tinted.

18. The package of claim 1, wherein the second window comprises an opening within the secondary package.

19. The package of claim 13, wherein the opening is enclosed with a second material that is generally transparent.

20. An oral care package assembly, comprising:
a dispenser for an oral composition, wherein at least a portion of the dispenser is generally transparent; and
a secondary package at least partially encompassing the dispenser, wherein at least a portion of the secondary package is generally transparent;
wherein the respective generally transparent portions of the dispenser and the secondary package are at least partially aligned such that the oral composition contained within the dispenser is visible through the respective generally transparent portions of the dispenser and the secondary package.

21. The package assembly of claim 20, wherein the respective generally transparent portions of the dispenser and the secondary package each comprise a total area of greater than or equal to about 1 cm².

22. The package assembly of claim 20, wherein the secondary package is completely enclosed about the dispenser.

23. The package assembly of claim 20, wherein the secondary package and the generally transparent portion of the secondary package comprise a generally transparent carton.

24. The package assembly of claim 20, wherein the dispenser is non-cylindrical.

25. The package assembly of claim 20, wherein the secondary package comprises a housing that is semi-rigid.

26. The package assembly of claim 20, wherein the secondary package comprises a non-flexible film housing.

27. A method of displaying an oral composition, comprising:
forming a primary package for holding an oral composition;
forming a first window in the primary package;
forming a secondary package;
forming a second window in the secondary package;
placing an oral composition within a reservoir of the primary package; and
positioning the primary package at least partially inside the secondary package such that the oral composition is visible through the first and second windows.
